(19) United States
(12) Patent Application Publication
(10) Pub. No.: US 2017/0169364 A1
(43) Pub. Date: Jun. 15, 2017

(54) System and Method for Booking a Service

(71) Applicant: Stirling Hamilton KEEN, Tamarama (AU)

(72) Inventor: Stirling Hamilton KEEN, Tamarama (AU)

(21) Appl. No.: 15/377,218

(22) Filed: Dec. 13, 2016

(30) Foreign Application Priority Data
Dec. 15, 2015 (AU) 2015905185

(51) Int. Cl. G06Q 10/02; H04L 29/08; G06Q 20/10

(52) U.S. Cl. CPC G06Q 10/02; G06Q 20/102; H04L 67/306

(57) ABSTRACT

A system for booking services, the system comprising a server, the server adapted to receive at least a first data set input by a first user. The first data set comprising at least one data set for a booking for services, the server adapted to receive a revised first data set input by the first user to modify the first data set to alter the booking for services, such that a second user can send a second data set to the server to book for services in place of the first data set; and wherein the first data set is modified after receiving the second data set.

### CROSS-REFERENCE TO RELATED APPLICATIONS

This application claims foreign priority to and the benefit of Australian Patent Application No. 2015905185, filed on Dec. 15, 2015, which is incorporated herein by reference in its entirety.

### FIELD OF THE INVENTION

The present disclosure relates generally to a system and method for booking childcare services. More particularly, the present disclosure relates to a system and method for allowing remote booking and cancellation of services, particularly childcare services.

### BACKGROUND OF THE INVENTION

Parents with children will understand the need for booking childcare services and the potential for changes in need for childcare services and the reliability for booking childcare services consistently over a period of time.

There are a number of known systems which are adapted to book and manage bookings for a service or event. However, there are a number of common needs across these systems which have not yet been addressed, such as optimising the capacity of a service provider and minimising the impact of cancellations.

Services that are booked or used via the Internet are constantly increasing. The Internet enables one to use several on-line services such as services connected to banks, health services, travel agencies, child care services, and vehicle maintenance services.

The increasing popularity of mobile computing and communications devices introduce new challenges to services on the Internet. Mobile devices are able to deliver information to users when needed and where needed. Users want access to information and applications from a device at hand. Users may further want to access and update this information wherever they happen to be.

It is important to notice, however, that not all the devices will be mobile. Future services are generally able to communicate with a large variety of devices, both those that are mobile and those that are not, for example a server. Different devices, such as laptops, tablet computers and smart phones have very different capabilities and therefore, each device may not be able to generate a booking or cancel a booking.

Previously, there have been many services able to manage bookings. In a limited sense, these systems include for example booking appointments for health services; booking travel reservations for hotels, airlines, and rental cars; booking tickets for venues; booking appointments for vehicle maintenance; booking maintenance for apartments; and so on. It would be useful, if those services could aggregate information from each another. For example, if a customer is booking tickets for a concert, he or she might want to book a table in a restaurant also. It helps, if the restaurant's booking service gets basic information, like date and a customer name from a theatre booking system. However, current systems generally may not allow for users to make bookings across more than one venue or location. As a further example, a user may wish to book childcare at more than one location, but is typically required to reenrol for each new location selected, this is time consuming and may lead to multiple accounts being generated for a single user. It may be advantageous to have a centralised booking system which allows for remote booking and cancellation.

Another problem with current booking systems is that they do not allow users to have interactions with multiple centres or places such that they can manage multiple clients at the same time. For example, if a user has multiple clients in their care which are required to be enrolled across multiple locations, the user cannot communicate with all of the centres through a single location.

Further, currently users may potentially cancel bookings accidentally, which may cause further problems. As such, it would be beneficial for a system to have a delayed time for booking cancellations before the booking is cancelled.

Transportation carriers, such as airlines, trains, bus companies or reservation booking services, such as child care centres, theatres and restaurants generally employ some type of reservation and booking system. Such systems are used to book at least one of a user or client arrivals and departures. These types of systems share a common need to rebook and/or cancel bookings due to events which may be unforeseeable. For example, a child booked into childcare is ill or a commercial airlines is affected by travel events that include flight schedule changes, routing and equipment changes, flight delays or cancellations because of weather or some other reason, voluntary and involuntary denied boarding, or other similar occurrences.

Booking system providers may typically have 5% to 10% of bookings not show for a service, such as childcare or a reservation. This may be due to a number of reasons and may exclude others from being able to obtain a booking despite vacancies.

Further, known systems generally do not allow for users to directly request to alter a placement or booking with another user of the system. This lack of interaction between users can burden the system operators and service providers with unnecessary tasks which consume time that can be spent doing more productive tasks.

It may be advantageous to allow for users and centres to manage bookings through a digital format and communicate with users more effectively.

Any discussion of the prior art throughout the specification should in no way be considered as an admission that such prior art is widely known or forms part of common general knowledge in the field.

### SUMMARY OF THE INVENTION

### Problems to be Solved

It may be advantageous to provide a system for booking childcare.

It may be an advantage to provide a system which allows remote booking and cancellation of childcare services.

It may be desirable to provide an efficient booking system which reduces the potential for loss of revenue for service providers.

It may be desirable for a user of the system to obtain a refund or part thereof, if a booking is cancelled, swapped or otherwise altered.

It may be advantageous to allow a user of a system with a cancelled booking a cooling off period to reacquire a booking.

It may be advantageous to allow a user to offer a cancellation booking for a service which is subsequently cancelled only if another user takes the cancellation booking.

It may be advantageous to allow users of a system to be on a waitlist to ensure available bookings for a service are filled.

It is an object of the present invention to overcome or ameliorate at least one of the disadvantages of the prior art, or to provide a useful alternative.

### Means for Solving the Problem

A first aspect of the present disclosure may relate to a system for booking services. The system comprises a server in which the server is adapted to receive at least a first data set input by a first user. The first data set comprising at least one data set for a booking for services. The server adapted to receive a revised first data set input by the first user to modify the first data set to alter the booking for services, such that a second user can send a second data set to the server to book for services in place of the first data set; and wherein the first data set is modified after receiving the second data set.

In at least one embodiment, the first user and the second user have a respective user profile. Preferably, at least one of the first user profile and the second user profile each have an associated client profile. Preferably, the first data set further comprises at least one of; booking time data, a booking period data, booking date data, data relating to a requirement for the booking, data relating to a request for the booking, client data, user data, and authorised user data. Preferably, the services are selected from the list of; childcare services, dining reservation services, transport services, medical services, repair services, and educational services. Preferably, the system may be adapted to aggregate data from a plurality of service providers, such that the system may be able to modify a booking for a user. Preferably, a payment may be required from the second user to book for services in place of the first data set before the first data set is modified after receiving the second data set. Optionally, the system may be adapted to perform a check for at least one available booking at a requested booking time. Preferably, when there is not at least one available booking at the requested time, at least one alternative available booking may be offered to a user, if there is at least one alternative available booking. Preferably, the at least one alternative available booking may be offered with respect to at least a requested booking time and/or a location of the booking. Preferably, the location of the at least one alternative available booking may be within a predetermined radius the location of the booking. Preferably, the system may comprise a wait list in which users can queue for the booking in place of the first user. Preferably, the users on the wait list may be assigned a rank which relates to the time in which they were added to the wait list. Preferably, when the first user alters the booking for services, an availability notification may be sent to at least one user on the wait list to such that a second user can book services in place of the first user. Preferably, wherein users on the wait list may request to swap waiting list ranks, such that a user added to the wait list at a later time can swap with a user added to the wait list at a respective earlier time. Preferably, the second waiting user may offer an incentive to the first waiting user to swap waiting list ranks. Preferably, when the second user sends the second data set to the server to book for services in place of the first data set, such that the first user may receive a partial reimbursement of an original booking fee. Preferably, the partial reimbursement of the original booking fee reimbursed to the first user may be relatively larger when the second user books services in place of the first data set within a predetermined time period.

In the context of the present invention, the words “comprise”, “comprising” and the like are to be construed in their inclusive, as opposed to their exclusive, sense, that is in the sense of “including, but not limited to”.

The invention is to be interpreted with reference to at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1A depicts a first portion of a flowchart of an embodiment of the system of the present disclosure;

FIGS. 1B to 1F are portions of the flowchart to be viewed with respect to FIG. 1A, in which the prime letters of FIGS. 1A to 1F indicate connection locations between respective flowchart portions; and

FIG. 2 illustrates a flowchart of an embodiment of a booking and cancellation process of the present disclosure.

### DETAILED DESCRIPTION

Preferred embodiments of the invention will now be described with reference to the accompanying drawings and non-limiting examples.

In an embodiment of the present disclosure, there is provided a system 10 for making a booking. The system 10 is adapted to allow a user of the system 10 to search for a desired booking availability 100. The desired booking availability may be assigned at least one predetermined booking data set, such as a location, a time availability, staff names, number of staff, activity information, meal information,

A first user of the system preferable has a user profile associated with the system, or a user profile associated with another system, such as a social media profile, an electronic profile. A membership with an organisation or another third party may also be sufficient for use as a user profile, however it is preferred that the first user generates a profile when using the system.

The system may have a number of distinct functions or processes such as; core processes, waitlists, notifications, payment systems, at least one user profile, at least one centre profiles, rating system, reporting system, centre support, special functions and customisable inputs.

In a further embodiment, the core processes of the system 10 may include a sign up process, a login process and a logout process. This allows a user to sign up to the system 10 and generate a user profile specific to a user of the system. The user profile preferably comprises at least a user name or assigned identification and an associated password. The user profile may further comprise details about the user, at least one further person associated with the user (such as at least one client), contact details, system preferences, system instructions, payment details (e.g. credit card details, PayPal™ or any other predetermined payment method), or any other predetermined information field. Optionally, the user may provide additional information in the user profile which may be either publically accessed or accessed by an authorised user of the system.

It will be appreciated that the at least one further person associated with the user may be a relative of the user, under the care of the user, a family member of the user or have any other relationship which allows the user to have the capacity to book an event or placement for the further person. The user and/or the at least one further person may be the client of a booking.

Known login and logout processes and systems are typically suitable for use with the present disclosure. Further, known logout processes may also be used with the present disclosure. Preferably, the system 10 is provided security processes, such as a logout timer such that a user profile is automatically logged out after a predetermined period of time of inactivity. Other security features may also be used by the system of the present disclosure.

After a user profile has been generated, the system is preferably adapted to allow the user to make a single booking request or multiple booking requests. The multiple booking requests may allow a user to book a plurality of periods of time, for example at a regular interval, such as consistent weekly bookings, or request bookings at any desired period. This may allow a user to book multiple periods over the course of a desired time period, for example, days, weeks, months or years.

The user may make a single booking request or multiple booking request with the system 10. The bookings may be made for one or more clients associated with the user profile. The booking requests are then compared with available places within the system 10.

The above process differs from known systems in that the system performs a check to determine whether there are any available bookings at the requested booking times. It will be appreciated that the terms ‘booking times’ and ‘booking periods’ may be used interchangeably thought this specification. The system may return results which match the requested booking times if any are available, and optionally the system may suggest alternate bookings based on similar availability times. For example, if a request for a booking is received from a user profile for a booking for a client at 10 am on Monday, and an available slot is open at 11 am on Monday, the system may offer this booking time to the client as an alternative to the 10 am booking or may offer a booking either side of the requested date near to or at the same requested booking time.

In a further embodiment, the system 10 may be adapted to offer an alternate location for the booking in a nearby centre or complex if there is a booking available or if there is a near enough location to the location of the booking request centre. It will be appreciated that a ‘near enough location’ may be within a radius or distance determined by the user or by the system, for example, a radius of up to around 20 km (kilometres) may be selected. Other distances may also be used by the system of the present disclosure. Optionally, the system may allow suburbs or postcodes to be selected to expand or narrow the search for a booking location.

The system may further allow narrowing of search results by allowing a user to apply one or more filters to the system. Filters may allow a user to provide a hierarchy of locations or time preferences to be selected such that the user can more quickly request a booking. The system may allow the user to save the hierarchy or allow a user to associate the hierarchy with the user profile. Filters may include at least one of a geographical filter, a date variance filter, a class size filter, a centre filter or any other predetermined filter. The class size filter may be used for requesting a booking with a predetermined minimum or maximum number of people. For example, it may be preferred to have booking with a larger number of people for a social or marketing event, or make a booking with fewer people for learning classes.

Results from the booking requests may then be displayed to the user. The results may return multiple matches or options for the user to select a booking request if multiple matches are found. The system may offer suggestions or highlight which bookings are the closest or exact match to the booking request. The system may be adapted to allow a user to select a potential available booking for additional information before committing to making the booking. Optionally, a timer may reserve the displayed bookings for a predetermined period of time such that another user of the system cannot place a booking at the same time for the same availability.

The system may be adapted arrange and display to the user available bookings in a priority list. The system may further be adapted to predict or offer suggestions for booking requests based on at least one of a previous booking, a previous search or user profile data. Optionally, booking results displayed may include information with respect to the capacity (in the case of classes) or whether the booking corresponds to a cancellation of a booking.

The results view displayed to the user may be altered by the user to be displayed in at least one alternative format, based on the users preference. This may allow the user to more easily view options for booking requests. Optionally, the location results may be displayed to the user on a geographical map. The map may allow the user to more easily identify nearby locations for ease of access to the centre or to make bookings at multiple locations.

If the user selects to progress with making a booking for a service, such as a class booking, a personal booking, a childcare booking, a carer booking or any other predetermined booking. The system may identify to a user whether there are any conflicting bookings or offer suggestions if two bookings are geographically too far apart to be able to make both bookings. For example a user has a booking at 10 am at location A, and a 10.30 am booking on the same day at location B which is a distance that is 100 km away from location A, the system may notify the user that the distance between these locations and the times of the appointments may cause a conflict or a missed booking. Alternatively, the system may allow a user to place a booking to replace an existing booking, and may form a cancellation request or modification request for previous booking. Optionally, the system may allow to users to swap bookings between user profiles.

The availabilities may be listed by the system as available until a booking request is processed, the period of care has expired, or the availability has been removed or modified by the centre or a representative of the centre. The period of care may be dependent on the start or the end of the care period.

In another embodiment, the system may allow a centre to operate as a ‘place user’ for the listing of vacancies. This allows one organisation to control multiple childcare centres through one system. A ‘place user’ centre is preferably verified by the organisation to which the place user is claiming to be affiliated with. This allows an organisation to minimise the potential for fraudulent place users to pose as another organisation to which it is not affiliated. Further, having a place user may enable centres to have a greater flexibility in the scope of the place being made available. For example, the availability may be made for a day care in which the child can be of any age, rather than a restricted age group.

In yet another embodiment, the place user can be a parent or guardian. Further, the system may be adapted to verify that a position offering is a real position to avoid double bookings.

A centre may optionally be able to cancel a placement or restrict or expand the number of bookings available, relative to a regular booking period. For example, a regular booking period may allow 10 clients to be booked, but the centre may choose to restrict the number of clients to a lesser number if staff members of the centre are unavailable. Further, the booking time may also be varied by the centre if extended or reduced times are available, for example on a public holiday the hours available may be reduced relative to a regular booking period. Preferably, the system only allows non-booked places to be cancelled or otherwise modified such that conflicts with existing bookings may be avoided to maintain customer satisfaction.

If a user, or first user, of the system wishes to cancel a booking which they have made, the first user sends to the system from their respective user profile a cancellation request. The system is preferably adapted to receive the cancellation request of the first user, but does not cancel the booking until another user, a second user, takes the place of the booking. This allows the first user a period of time to change their mind and withdraw the cancellation request, but also allows the centre with the booking to retain the payment of the first user in the event that a second user does not request the booking of the first user.

If a second user requests the booking from the first user, the first user may receive a refund of at least a portion of the original booking fee, or may receive an amount of credit for the centre. Alternatively, the first user may not receive any refund or may receive a credit to an account or another form of reimbursement for the cancellation. It will be appreciated that a cancellation within a predetermined time period may also effect the reimbursement received by the user for the cancellation. For example, cancellation and rebooking within 24 hours of the scheduled booking period may result in a lower amount being reimbursed.

A centre may display a full booking to a searcher, but may simultaneously indicate that at least one of the bookings are available to be rebooked, if a cancellation has been requested. This is to say that all bookings for a service have been booked, however a service may be available for a further user to replace the original client who has shown intent not to utilise the booking.

Preferably, the system is adapted to place users onto a wait list such that the at least one user on the waitlist can receive an availability notification if at least one user with a booking requests a cancellation of a booking. The waiting list preferably has a hierarchy which allows a user placed on the wait list first or a user of high priority to be issued a notification, such as an availability notification for the cancelled booking, and have the first right of rejection or acceptance for the booking. If the first user does not respond to the availability notification within a predetermined time period, the system may issue a notification to a further user on the waitlist, if any, and issue the availability notification.

In yet a further embodiment, if the booking is cancelled within a predetermined time relative to the booking, for example, within 48 hours of the booking, each person on the waiting list may be issued a notification such that there is a greater possibility that the cancelled booking is replaced with another booking. It will be appreciated that the centre may alternatively manually issue notifications or manually book a second user such that more urgent booking requests may be filled first, regardless of the waiting list hierarchy.

The system may allow for a validation of a user booking, or bookings, to ensure authenticity. Validation methods may include manual communications to centre with manual system authentication for each booking and transaction associated therewith. In a further embodiment, the validation may be an automatic match for at least one user booking with a centre direct to a centre's system or authentication of bookings with centres at user sign-up. Other validations may be performed by the system, such as payment validations, a centre validation, a user validation, or any other validation process to ensure both the centre and the system are approved to make and/or accept bookings.

Optionally, the system may comprise Customer Relationship Management (CRM) functionality. The CRM functionality may allow for the system and associated operating business, or optionally centres, to have a level of relationship management, which also may assist with data collection and service improvement with users and centres. The CRM functionality may be customised, such that data collection can be more tailored enabling reporting to centres. For example, the CRM may be adapted to track the moods of clients or users of the user profiles and track satisfaction and dissatisfaction towards centre decisions or actions, which will allow the system and/or associated business and/or centre to take a different approach for different customers. Further, the CRM may be adapted to automate at least one of the processes of the system and allow an improved user experience. The CRM functionality may also allow for the system and/or centres to more effectively target customers for repeat business.

The system preferably allows communications between the user profile and the centre via a communications interface. The communications interface may provide for a text chat or online or intranet messaging system such that a user can communicate with other users of the system or may communicate with centres. Optionally, the communications interface includes details such as email addresses, contact phone numbers, mailing addresses, head office addresses or any other predetermined contact details. For example, the communications interface may allow for a user to be contacted if an incident has occurred with a client, such as an injury, may allow a user to indicate to a centre of a change in booking requirements, or may allow a centre to communicate reports regarding the client at the centre. The communications interface may have a frequently asked questions section or may support a questions and answers communication.

If a user is placed on a waitlist, the user may cancel their position on the waitlist if they have obtained another booking or if they no longer wish to place a booking. In yet a further embodiment the user on the waitlist may view their current waitlist position, and optionally lower this position. The system may further allow a user to request priority for their waitlist position, and if the system or other users agrees to the request, the users may swap positions on the waitlist. Optionally, the request for swapping waitlist positions may be accompanied by a nominal fee or other incentive, such as a message, to entice the person with a higher waitlist position to swap waitlist positions. The system may further allow a centre to cancel a booking availability if the booking availability has not been filled, or if there are circumstances for the booking to be cancelled. The centre may notify the user of the cancellation and offer suggestions for alternative bookings at other centres or locations if there are availabilities at the other centres or locations.

The waitlist to which a user can join, may be defined by certain criteria, such as a predetermined time period or centre. The user may further have the option to automatically accept a booking if a booking is offered to the user on the waitlist, such that the user can obtain the booking without further input into the system at a later time. This may allow users with a heavy work load or who are not contactable to utilise the waitlist feature of the system. The waitlist may further prioritise a user based on a user profile level, for example a “gold account” may receive a priority over a “silver account” and be placed ahead of the silver account user on a waitlist. It will be appreciated that the terms “gold account” and “silver account” are purely exemplary and any naming convention or other predetermined account differentiator may be used by the system. In yet another embodiment, the system may also prioritise a user based on the number of waitlists the user is on, the number of historical bookings made or any other predetermined factor.

The system may calculate the probability of obtaining a booking at a centre based on at least one of the booking request day, the time period of the request, historical cancellation or availability rates for a particular booking period or any other assigned factor. The probability may be displayed to a user such that they can determine whether they wish to be placed on a waitlist or expand the parameters of the booking request to increase the probability of obtaining a booking, for example, expanding the region they will accept a booking within. Alternatively, the probability may be converted into words, for example a 90% or higher probability of a position becoming available for a centre may be assigned a “very high” message to be displayed to a user, or a probability of 40% or less may be assigned a “low” or “very low” message.

If a user on a waitlist is notified about an available booking, the booking notification may also include at least one of cost information, such as payment details, refund details, description of services available, terms and conditions of the booking, and centre details. Optionally, the notification may also display who cancelled the booking to make a booking available. The notification may also include hyperlinks or other access means to make a booking and/or process payment for the booking.

A booking confirmation or booking processing notification may further be sent to a user after making a booking with at least one centre. The booking confirmation preferably includes a receipt and/or location and time details of the booking. After a booking request has been processed, it is likely the child care centre will have the booking recorded in their database if accepted. The system may be adapted to allow the centre to manually confirm bookings or automatically confirm bookings. Optionally, the centres may have a list of users which require manual acceptance for booking requests. Accepted bookings stored by the system may be associated with the user details of the booking request, and may have payment and financial details of the user, as well as booking times, locations and any special requirements for the booking. This information may be shared from the system with the centre for the corresponding booking and may enable user updates to be shared with the centre.

In yet a further embodiment, the system may be adapted to offer discounts or a fee reduction to users if the centre has available bookings near to the booking period to entice customers to make a booking. Optionally, customers may swap bookings without a cancellation request. If users swap bookings preferably both users and the centre or centres are notified of the swap such that the centres can accommodate or reject the booking swap.

Preferably, before bookings can be swapped, the respective centres or an administration for both centres confirms the booking, such that clients which cannot be accommodated are not processed and a swap does not occur. This further provides centres with successful swaps a chance to review any special needs or requests of the user for the client. A time period may be established which does not allow swapping of a booking, for example several hours prior to the booking.

Preferably, at least some of the booking, waitlists, swaps or any other data entered into the system is recorded, and more preferably all of the bookings are recorded by the system for data collection.

The system may further be adapted to allow notifications to update user profile details if they exist beyond a period of time without amendment. This can allow a user to ensure that their details are correct and that the system retains up-to-date information for the user profile. If records are deemed out-of-date the system will prompt the user to update their details at their earliest convenience, or may force the user to confirm that their details are correct upon logging in before allowing access to the functions of the user profile.

Preferably, a centre has a profile which can be displayed to users of the system. This allows a centre to outline advantages and benefits of booking a service or appointment at their location. The centre profile may be editable by employees or authorised persons of the centre and may allow users to provide a review or rating for their experience. The reviews or ratings may be manually approved by the system operators or centre for display or automatically displayed by the system, such that negative reviews may be seen by users.

Personal information or confidential information can be stored by the system or may be accessible by the system via a third party application. The personal information of the system is preferably securely stored behind safety protocols such that other users or unauthorised persons cannot access private or confidential information. The data stored by the system is preferably deleted and non-accessible if a user closes their accounts; however transactional history or other essential information for regulatory, taxation or business purposes is preferably retained.

To facilitate a booking, a user can make a payment for a booked service and any related charges. Optionally, the system may allow for an incremental payment or other payment plan to incrementally pay the fee for the booking. A notification may be issued to the user of successful transaction and optionally to provide alternate means of payment if a payment attempt is unsuccessful. Payment may be made as a booking process step enabling a booking to be confirmed or completed.

A reward or loyalty program may be used by the system of the present disclosure. The loyalty program may allow a user to accumulate points or another virtual currency which may be exchanged for goods, services or discounts or any other predetermined reward. The virtual currency acquired by a user may be adapted for use with external rewards programs or other systems.

Virtual currency may be issued or revoked based on the user making a payment, receiving a refund or redeeming a reward. Virtual currency may further be issued for any other predetermined event or manually assigned to a user by the system or a centre.

A user may be charged for accessing or booking a service, or any other predetermined action. Optionally, the system will allow prepayment for goods or services, such that a user can receive discounts or package deals for making bookings or requesting services.

The user may generate at least one client record, which may include a respective client date of birth, details of preferred centre bookings, medical details, special care requirements, power of attorney, signed agreements, immunisation records, copies of relevant official certificates, next of kin contact details, residential address, or any other predetermined documents or information. Data may be altered by a centre and/or a user of the profile. Some data may be locked to only enable editing or viewing by system operators, users or centres. Insufficient data associated with the user may restrict access of the user to request a booking.

Preferably, the system allows for storage and retrieval of documents associated with a user profile, this may include, for example, a driver licence, birth certificate and immunisation records. System may store verification process details including date and parties involved in the verification. For example, consent forms for care of a client or immunisation records.

Information stored by the system, with consent of the user, may be made available to at least one third party. This may include new centres opening which are nearby or of may be of interest to the user, for example if the user is on a waitlist for a first centre and a second nearby centre has a booking availability, the second centre may issue a notification or other message to the user regarding the booking availability. User information may further be stored by the third party if consent is given.

Multiple users may be assigned to a user profile, for example, a first guardian and a second guardian of a child may both be users of the profile to manage day care bookings for the child, and may have consent to enrol the child into care and retrieve the child from care at the expiration of the booking time period. Further, one user may be able to remove another user form the system, for example in the case of only one guardian being eligible to enrol and retrieve a child from day care.

A centre may display additional desired information to users, such as speciality services, staff on duty for a booking period, client access means, opening hours, staff profiles, services facilities, or any other desired information. Optionally, the system may allow a user to request a booking based on one or more of these attributes including minimum staff numbers working at the time of the booking or whether a particular employee (or staff member) is available in a particular booking period. For example, if employee A is a preferred service provider for a client, the user may search for employee A, regardless of the centre location or time, and if employee A is working, the system may display to a user the booking periods in which employee A is working and the centre locations.

The operating business may choose to use variations of the system of the present disclosure. For example, a base package system may be offered and a higher tier system may also be offered, such as a premium package. The operating business or centre may promote to a user which level of the system is being used to attract potential new customers. Further, having a higher tier of the system, relative to the base system, may allow the centre to position advertising in user searches such that more effective advertising may be displayed to a user. Other advertising may be used throughout the system.

If a booking has been made with a centre, after the booking has been attended the user may upload a review and/or rating to the system such that other users may be more informed about the quality of the centre. The system may have a log of clients who have attended, and if the client has not attended a review function may not be available for the user to provide a review or rating. Alternatively, the system may only allow a user to provide a review within a defined period after attendance at the centre. The review and/or rating may comprise a message generated by the user based on the client experience.

System operators and/or centres may be allowed to edit and approve comments, reviews and rating prior to display to the public. Alternatively, centres may be able to make comment in reply to user comments. This may prevent potential inappropriate comments or reviews from being posted which may prejudice other users on the system, and allows the centre to reduce the potential for profanities to be displayed to other users.

The centre rating is preferably an aggregation of all user ratings which has been averaged to display the overall user rating. This may be a star rating system, a numerical rating system, a colour coded rating system or any other predetermined rating system which may convey to a user the quality or user satisfaction of the centre. Optionally, comments may be used to influence the rating based on key words found within comments posted by users.

Other features of the system may allow for reporting of revenue generated, expenditure, number of bookings made, rate of successful bookings, historical booking periods, conversion of bookings or other information which may be used for taxation purposes or government regulatory purposes. Further, the system may be adapted to issue reminders to centres when relevant licences, if any, are due to expire or when documents are required for submission, such that centres are less likely to miss deadlines for licence renewals or document submissions.

A calendar or user schedule may be displayed in a user profile which displays to a user the upcoming bookings and any waiting lists the user has applied to be on. The details of the booking may be displayed with the booking, for example, the location of the booking, the time of the booking, the fee for the booking, refund levels, and rewards gained from the booking.

In yet a further embodiment, optionally, the more bookings associated with a user profile, the more of a refund is gained by the user if a cancellation is required. For example, a user with 10 or fewer bookings may be entitled to a 50% refund for a cancelled booking and a user with between 10 to 50 bookings may be entitled to a 70% refund for a cancelled booking. This allows a user to be rewarded for being a repeat customer. Optionally, the system may allow a predetermined number of bookings to be cancelled without incurring a cancellation fee, such that the user receives the entire booking fee as a refund.

Further, the booking data may be filtered to a defined set of parameters such as bookings or placements within a defined period for one or multiple children associated with the user. The historical booking data may also be presented to a user of the system in a report format, which may be useful, for example, to track the number of days a client attends a booking per week, month or year. Other data may be stored by the system and used to generate a report. A report may be emailed or displayed to a user via the user profile. A reporting schedule can be automatically generated for a user if the system is adapted to do so. It will be appreciated that a user may manually make additional bookings at a centre and these manual bookings can be associated with a user profile. It will be appreciated that multiple bookings for the same time period may be booked by a user if they have a plurality of clients or wish to make more than one booking.

A user schedule may enable modification to bookings or placements, this may include being able to make a placement recorded in the schedule against a current booking or to make an additional booking request.

The centre may collect attendance to allow accountability of clients in the event of an emergency. The attendance record data may be used to generate at least a portion of a report for a user. Further, the system may provide an independent or integrated capability enabling a centre to track client attendance against system bookings.

The system may further provide an independent or integrated method for updating administration systems and reports. This may be advantageous for payment records, accounting records, accounting systems, government reporting and rebate processing. As such, the generated reports may be retained by the system and the system may allow for other third party reports or other centre reports to be integrated into a centre system for more complete recoding of records.

The pricing of bookings for service or goods may vary depending on historical records or the rate at which available bookings are filled. A variable pricing of services at different periods may create incentive for bookings and placements to influence demand and supply. Further, the system may allow a bidding process to obtain the booking.

Users may further receive rewards, such as loyalty scheme rewards or payment for referring new users to the system. Further a loyalty scheme may provide a user with special services or priority of access to services and benefits based on a user prioritisation method. A scheduled booking process may be employed by the system, in which user profiles with an associated priority for a booking may have first right to request and secure a booking. For example, a centre may assign a priority to a user for a calendar year, such that a client may make repeated generally consistent bookings for the year and secure any regular booking periods. This is to say that, for example, if a user makes a booking for every Monday for between 9 am to 5 pm, the centre may automatically accept the repeated booking request for the Monday period, however if the user wishes to make a booking request which is not a regular request, for example on Tuesday for 9 am to 5 pm, the user will need to check for an available booking and be placed on a waitlist if there are no available bookings.

The system may allow users to sign up to a routine booking waitlist at a single or multiple centres. System may draw on information contained within the user and client to facilitate the process. When an appropriate centre place (or booking) is accepted by the user, the user is able to remove their waitlist request from the waitlist of other centres.

Based on user profile information and other information gathered from third parties, enable an assessment of the authenticity of a user and or a user's bookings and provide a system alert to the business operators where necessary. Potential inauthentic users may be blocked from making a booking or placement until credentials are further verified. Optionally, users may be required to be authenticated before or after making a booking, for example a secondary password may be required or answering a private question.

Optionally, the system may allow at least a portion of a booking period to be booked. If a user requests a portion of an available booking, the user may still be charged the full booking rate, however, the system can record that a client will be only in attendance for the portion of the booking, and therefore the client must be at a suitable location to be retrieved. Optionally, each day may be split up into multiple increments such that incremental lots can be booked. For example, a single day may have 12 increments with each increment corresponding to an hour time period. This may allow a user to book 3 consecutive time periods in the morning and 2 time periods in the evening without being required to pay for a full day of increments.

It will be appreciated that the system of the present disclosure may take a portion of booking fees or cancellation fees. Alternatively, the system may take a royalty fee based on the number of bookings or transactions through the system.

It will further be appreciated that a centre can be any venue or location in which a service can be provided or goods can be sold. A user may also be a client, and the user may be making a booking for a client may mean making a booking for themselves.

It will be appreciated that each client may have a client profile associated with the user profile. Multiple client profiles may be associated with a user profile. Optionally, the client profiles may be associated with more than one user profile, such that two independent users may manage the bookings of at least one client. If a booking is requested and/or confirmed for the client, each user profile may be notified of the booking request. Optionally, a booking calendar for the client may be displayed to each user profile to avoid conflicting bookings. If multiple clients are associated with at least one user profile, the booking schedules or booking calendars for at least two clients may be displayed comparatively such that potentially conflicting bookings may be displayed to a user. Other predetermined information may also be displayed to a user when comparing calendars.

At least one rule may be associated with at least one rule or process that allows the system to automatically carry out at least one function or process. Preferably, if the system is adapted to accept or reject a booking request, at least one rule must be triggered for the system to accept to reject the request. A rule may be assigned by a centre, such that if a user profile requests a booking for a particular client, the particular client may trigger a rule to reject the booking request from being placed. This may allow users who are not suitable for a centre to be rejected. For example, if a particular client has needs which cannot be met by the centre, the centre may opt to assign a rejection rule for the client.

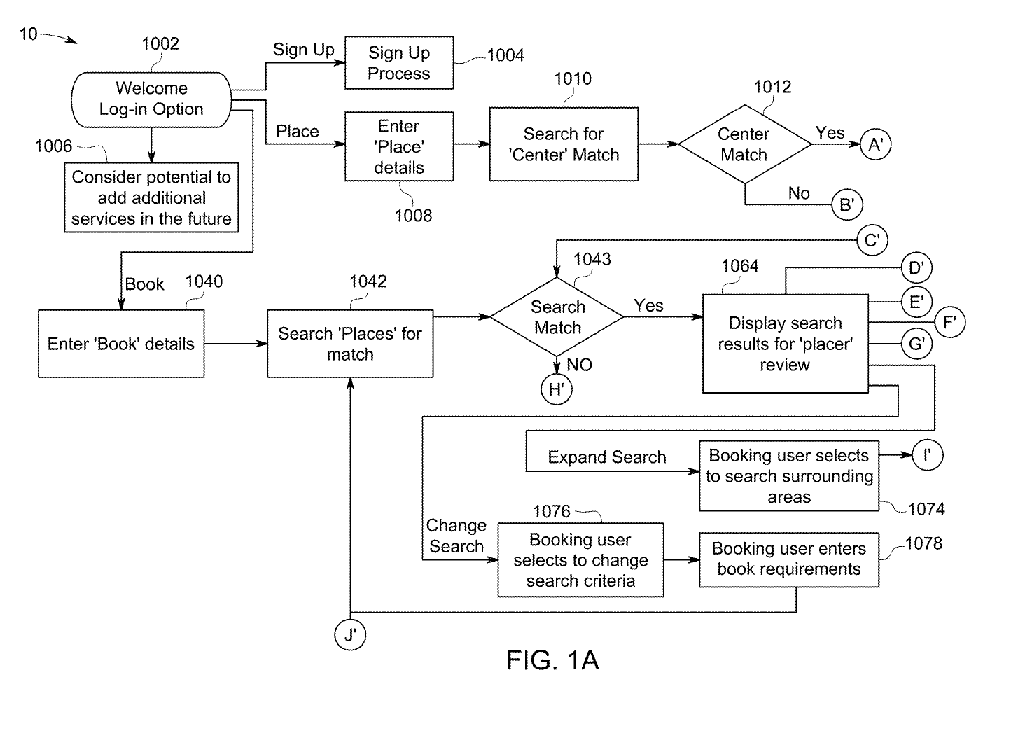

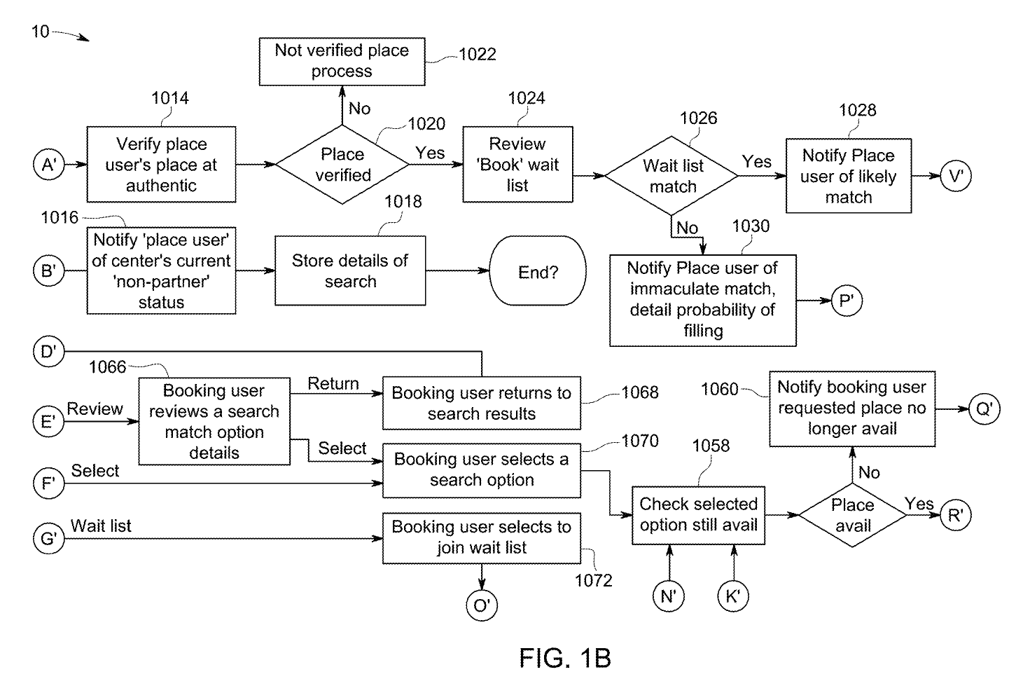

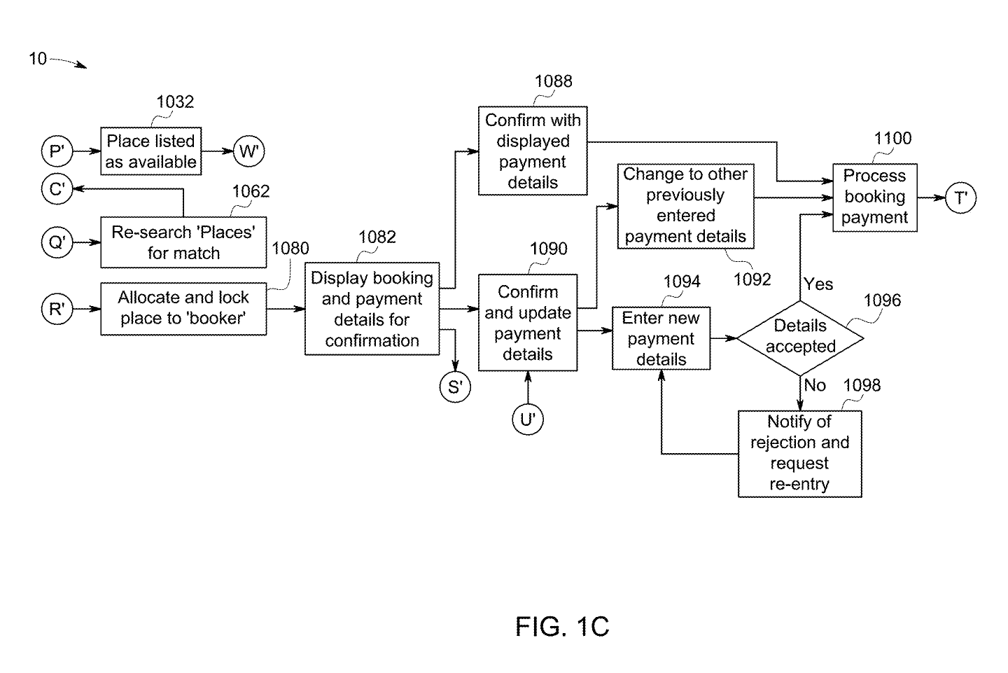

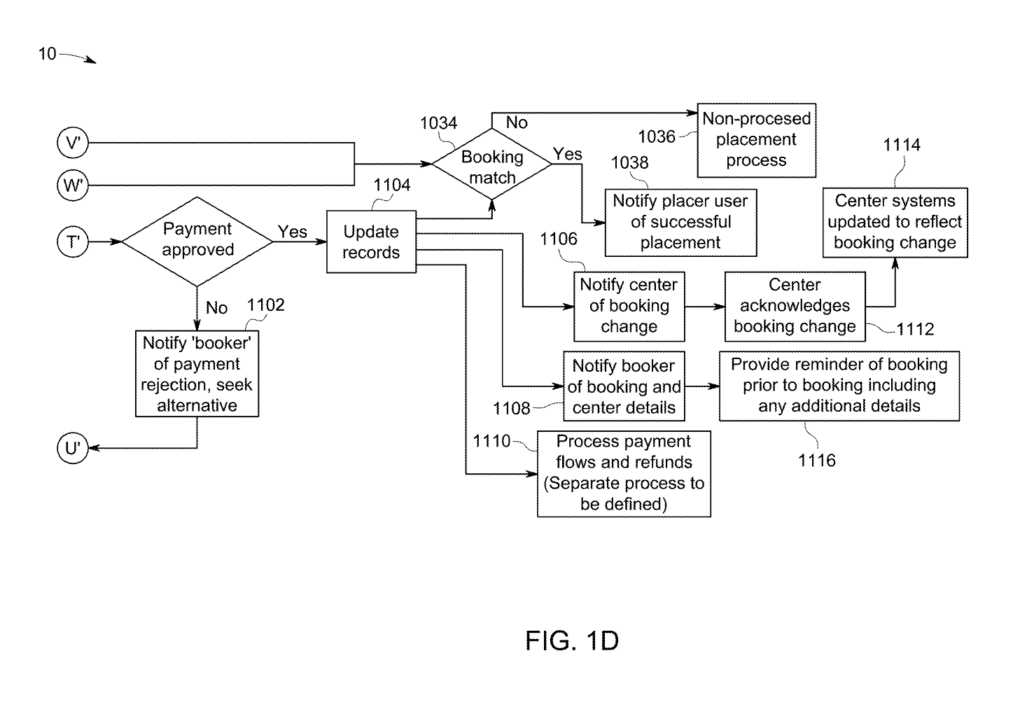

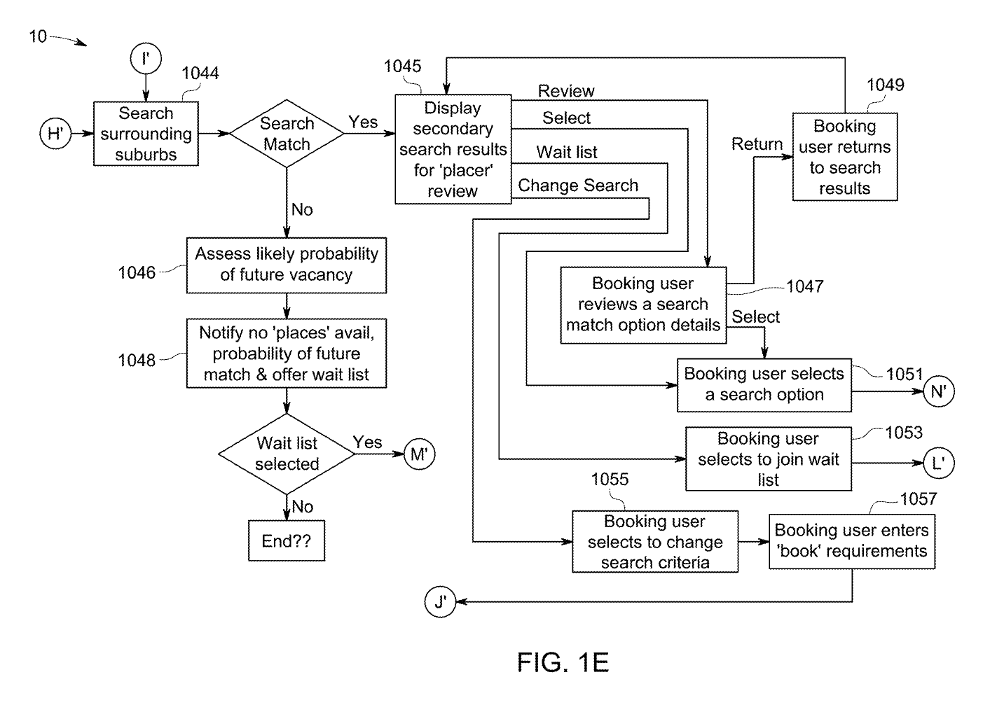

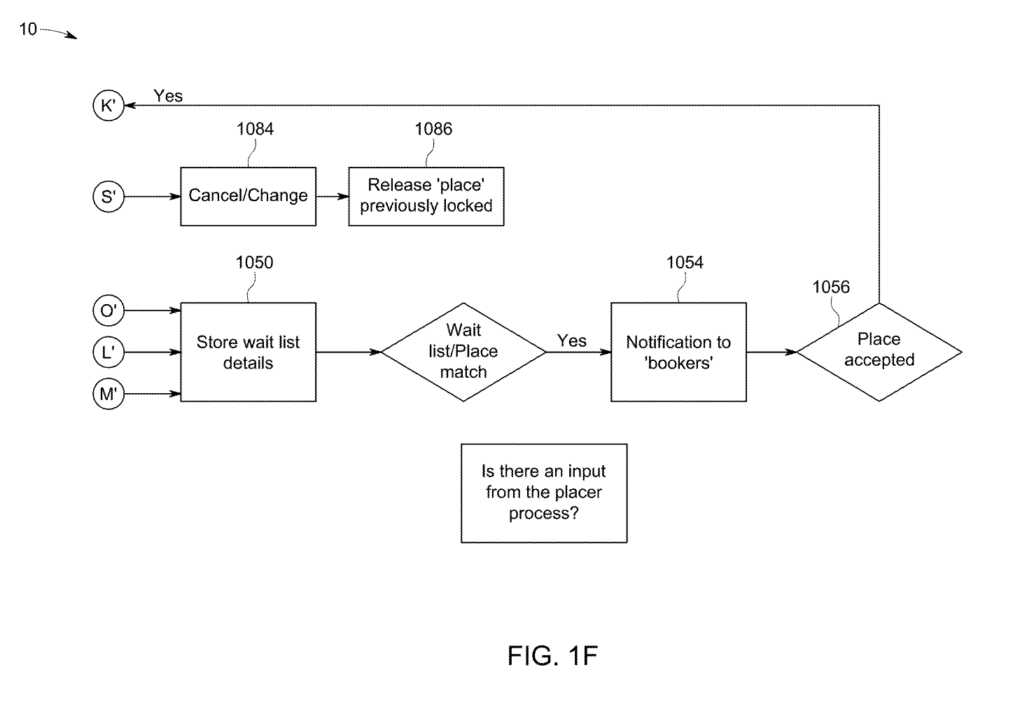

Referring to FIGS. 1A to 1F, there is shown a flow chart of an embodiment of the system 10 of the present disclosure. It will be appreciated that the prime reference letters in FIGS. 1A to 1F indicate how the flowchart connects between respective Figures of 1A to 1F. The system 10 allows a login interface 1002 to be displayed to a user and/or an enrolment interface 1004. Other predetermined options 1006 may be displayed to a user and/or client when accessing the system, such as terms and conditions.

After a user has logged into a user profile, the user can enter place details 1008, or have preassigned place location details entered. Place details may be associated with the relative location of desired booking services or a residential place, such as a suburb or postcode or may be an address of a centre. The user may then search known centres in, or near to, the place 1010 and the system determines whether any matches have been detected 1012. If the user searches for the place, the system may be adapted to display at least one centre in the desired place. The centres may or may not be filtered to display centres with availabilities.

If no centre matches are found by the system 1016, or a centre is found which is not associated with the system, it will notify the user. Optionally, the system may store details of non-system centres to be contacted at a later time 1018. The system may then end the process, or return the user back to enter place detail 1008 if further searches are to be conducted.

If the system 10 finds at least one match to the search, the system may be adapted to perform a check which verifies at least one place found is authentic 1014. A “place” may also be referred to as a centre. Verification of a place may then be determined 1020, in which the verification process 1020 may determine whether an operating centre has a vacancy for a user. If at least one place, or centre, cannot be verified a “not verified process” 1022 can be commenced by the system 10. The not verified process 1022 may contact the centre to verify the place or otherwise flag the centre for an operator of the system to confirm whether the centre should have a verified status.

In yet a further embodiment, the “place” as recited in the paragraph above, may be a centre.

When a place can be verified, the system 10 may review the book waitlist 1024 and a check is made 1026 to determine whether a place is available. If there is a waitlist match and a place is available a notification is sent to the centre or place user providing the availability depending on who made the place available 1028 to notify them of a likely match. If there is no waitlist match a notification may be sent to notify the centre (which may also be referred to as a place user) of the immediate match and the details of the booking. The centre may be listed as available 1032 for the user. The system 10 may perform a check to determine whether there is a booking match 1034.

If there is no booking match, the non-placement process 1036 may be commenced by the system, this may include an expiry of the place offer if no corresponding bookings have been made while the place is valid. If there is a booking match a notification may be sent to at least one of the centre and/or the user 1038 for the successful booking.

Alternatively to searching for a centre location, the user may wish to enter booking details 1040. The booking details may include a time, and date and location in which the booking is preferred to be made, which may also specify a preferred centre. The system searches for a match to the entered booking details 1042. If the system fails to return a match 1045, a secondary search result may be displayed to a user for review. The user may then choose to review a result, select a result, be added to a waitlist, expand the search, or change the search. A secondary search may be similar to the original or first search 1042 which was previously conducted, but may alter the previous search inputs or apply filters to the first search returned data.

Reviewing a result may allow a user to view further details associated with the available booking 1047. The further details may be at least one of; centre size, services offered, operating hours, staff numbers, staff names, special options for the booking, discounts for the booking, requirements for the booking or any other predetermined information assigned to be displayed with the booking. If the user does not wish to select the booking, the user may return to the available bookings displayed at 1049. If the user wishes to select the booking, the user selects the booking 1057 with the potential intent of confirming a booking request, and the system may then perform a check to ensure that the booking is still available 1058.

If there are no desirable available bookings or if the user is unsure whether they wish to proceed to confirm a booking option, optionally the user may opt to be placed onto a waitlist 1053. If there are available bookings, the user may be notified each time that an available booking is booked, such that the user may be enticed to make a booking due to the limited number of places available. Optionally, if the user is notified each time a booking is made, the notification may display to a user the number of remaining available bookings, or a centre may offer a discount to the user on the waitlist to entice them to make a booking. The user details may be stored on the waitlist 1050.

If the user selects to search the surrounding areas by expanding the search 1074, the user may allow the system to search for surrounding suburbs or additional suburbs 1044. Other locations relating to centres that the user has previously booked may be also added to the search and the adjacent suburbs near to the previously booked centres.

If the user has made an error or wishes to search for results again, the user may change the search criteria 1055 and the user may optionally enter alternate booking requirements 1057, and the system 10 searches for a match 1042 to the new search. It will be appreciated that the search criteria 1055 may be the same as booking user selects to change booking criteria 1076. Similarly, enter alternate booking requirements 1057 may be the same as a booking user entering booking requirements, as seen in step 1078.

If the search does not return a match 1043, surrounding times and/or locations may be searched 1044. If there are no further search matches the system may assess the probability for a future booking vacancy 1046. A notification may be displayed to a user indicating that there are currently no places available and allow the user to be placed onto a waitlist 1048. It will be appreciated, that if there is a relatively low probability, for example less than 50%, of being paced onto a waitlist, the user may be notified of the low probability for securing a booking. If the user does not wish to be placed onto a waitlist (also referred to as a waiting list), the user may end the search or restart the search to look for a different booking.

However, if the user selects to be placed onto a waitlist, the user details are recorded on the waitlist 1050. The system may perform a number of checks to determine whether there is a booking match 1052. If there is a match for the user, the system may notify the user of the match and booking availability 1054. The user may then choose to take the available booking 1056, however it will be appreciated that the user may also choose not to take the availability.

The system may further be adapted to determine whether there is an input from a placer process, such as a notice of availability of a booking or any other predetermined input process. If the booking is accepted, the system confirms that the booking is still available 1058 for the user to make the booking. If the booking is not available, a message or notice may be displayed to a user which indicates that the booking is no longer available 1060. The system may then automatically re-search the entered details 1062 if the booking is no longer available.

If the system searches for a match to the entered booking details 1042 and if the search does return a match 1043, the search results may be displayed to the user 1064 for review of the user. The user may then choose to review a result, select a result, be added to a waitlist, expand the search, or change the search.

Reviewing a result may allow a user to view further details associated with the available booking 1066. The further details may be at least one of; staff numbers, staff names, special options for the booking, discounts for the booking, requirements for the booking or any other predetermined information assigned to be displayed with the booking. If the user does not wish to select the booking, the user may return to the available bookings displayed at 1064. If the user wishes to select the booking, the user selects the booking 1070 with the intent of sending a booking request, and the system may then perform a check to ensure that the booking is still available 1058.

In at least one further embodiment, the user selecting a booking 1070 may be the same as the booking user selecting a search option 1051. These actions may include data from the secondary search.

If there are no desirable available bookings or if the user is unsure whether they wish to request a booking, the user may opt to be placed onto a waitlist 1072. If there are available bookings, the user may be notified each time that an available booking is booked, such that the user may be enticed to make a booking due to the limited number of places available. Optionally, if the user is notified each time a booking is made, the notification may display to a user the number of remaining available bookings, or a centre may offer a discount to the user on the waitlist to entice them to make a booking. The user details may be stored on the waitlist 1050.

If the user selects to search the surrounding areas by expanding the search 1074, the user may allow the system to search for surrounding suburbs or additional suburbs 1044. Other locations relating to centres that the user has previously booked may be also added to the search and the adjacent suburbs near to the previously booked centres.

If the user has made an error or wishes to search for results again, the user may change the search criteria 1076 and the user may optionally enter alternate booking requirements 1078, and the system 10 searches for a match 1042 to the new search.

However, when a user has selected an available booking and wishes to submit a booking request, and the system check to determine whether the booking is available confirm the availability of the booking, the system allows the user to allocate and lock the booking 1080. Allocating and locking the booking is preferably only temporary, such that if a user does not make a payment for the booking in a predetermined time limit, the booking is unlocked and a further user may select the booking to ensure that as many bookings are made as possible. The booking details and payment details may be displayed to a user 1082 and the user may review the details to ensure that the correct booking has been selected. Optionally, a discount, code or coupon may be applied when the user pays for the booking. The booking may be paid for by any conventional payment method, such as credit card, debit card, PayPal, DEFT, voucher, or any other predetermined method.

If the user does not wish to place the booking, or wishes to change the details of the booking 1084, the lock on the available booking may be released 1086 and the user may return to a previous selection option or may return to perform a different search.

A default payment method may be displayed to a user, such as prefilled credit card details or a prefilled electronic payment method 1088. The prefilled payment details may be retained from a previous booking, or may be filled in as part of the sign up or login process.

Alternatively, the user may update or be prompted to enter payment details 1090. If the user is prompted to enter payment details, the user may be presented with the option to have a set of prefilled payment details entered 1092, similar to that of 1090. If the user enters new payment details 1094, the system may validate or check whether the new payment details are correct or will allow for payment to be made 1096. If the new details are rejected 1098, the user can be returned to the new payment details input step 1094 or a previous step of the booking process.

If payment details are accepted, the payment can be processed 1100. If the payment is rejected 1102, the user may be returned to the payment input 1090 or another predetermined step of the booking process. Optionally, if the payment is rejected, a notification may be displayed to the user indicating a likely reason for the rejection of payment. If the payment is accepted, the records of at least one of the centre and/or the user may also be updated to reflect the booking and successful payment 1104.

Further, updating records may trigger at least one; notifying the centre of the booking 1106, notifying the user making the booking of the successful booking 1108, notifying the user who has made the booking place available, and may allow processing of payments to be recorded by the system 1110. Notifying the centre of the booking 1106 may allow the centre to acknowledge the booking has been made 1112, by confirming the booking or otherwise allowing a centre employee or centre administrator to know that a booking has been placed. The centre systems may be manually updated or automatically updated after the notification has been received or acknowledged 1114.

Notifying the user making the booking of the successful booking 1108, may also allow for reminders to be issued to the user 1116 nearer to the booking time. This may provide the user with a means for remembering to have a client attend the booking, and may reduce the potential for missed bookings. Other notifications may also be issued to the user, such as location changes, requirement changes, or any other predetermined message.

Referring to FIGS. 1A and 1B, it will be appreciated that the flowchart line A′ of FIG. 1A connects to flowchart line A′ of FIG. 1B. Similarly, B′ to O′, inclusive, of FIGS. 1A and 1B correspond in a similar relationship. This is to say B′ connects to B′, etc.

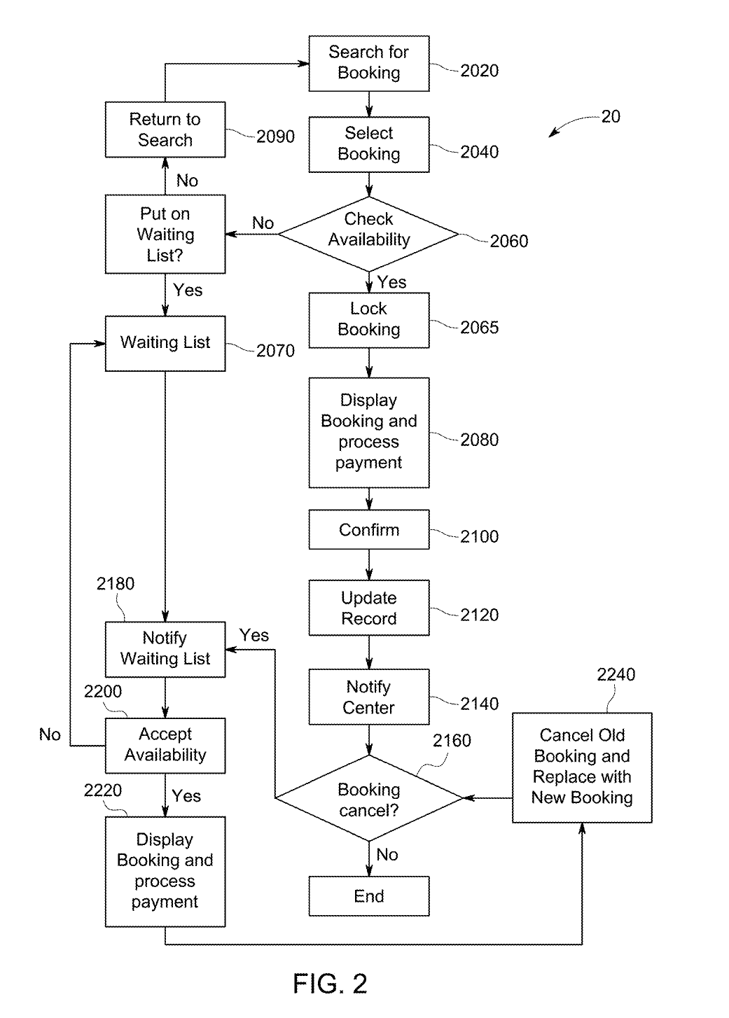

Turning now to FIG. 2, there is shown a booking and cancellation process of the present disclosure 20. A user searches for a booking 2020 and selects a desired booking 2040. The system then determines whether the booking is available 2060, and if the booking is not available the user may opt to be put onto a waiting list or waitlist 2070. If the user does not wish to be placed onto a waitlist, the system may provide the option to return to search for a booking or end searching 2090.

If there is an available booking, the system may be adapted to hold or lock the booking temporarily 2065 display at least one available booking to the user based on the search 2020. The user may select an available booking and send a booking request. The system may then choose to accept or reject the booking, based on at least one rule or process. If the request is accepted, the booking may be displayed to the user and may allow the user to enter payment details for the booking 2080. The user may then confirm the booking 2100 after entering all required details, such as the client for the booking, payment details or any other desired field.

The system 10 may then update the records 2120 such that the data generated by confirming the request is stored by the system 10. The centre in which the booking has been placed may optionally be notified 2140 that a booking has been made and update their records.

The user may have the option to cancel the booking 2160 by sending a cancellation request to the system 10 after a booking has been made, typically due to unforeseen circumstances. If the user does not cancel the booking the user may have a client attend a centre for the booking which has been made 2100. However, if the user chooses to cancel the booking, a further user on the waitlist can be notified by the system 2180. If no further users are on the waitlist, the booking may be listed as available if a further user searches for an available booking. It will be appreciated, that the first user wishing to cancel the booking may cancel the cancellation request, and retain the booking if no further user has accepted to take the available booking.

If the further user on the waitlist accepts the available booking 2200 (now referred to as a new booking) which corresponds to the cancelled booking, and subsequently facilitates payment for the new booking 2220, the booking which has requested to be cancelled is cancelled by the system and replaced by the new booking 2240. The user with the new booking may now have the options as commencing at step 2160. It will be appreciated that the further user may reject the notification for the available booking, and choose not to place the booking. It will be appreciated that other steps or checks may be included within the booking and cancellation process.

In yet another embodiment, a booking requested to be cancelled may not be cancelled until all remaining bookings for the time period are cancelled. For example, if a centre has ten (10) available bookings and four (4) bookings are placed, if one of the four (4) bookings are requested to be cancelled, the remaining six (6) available bookings must be filled prior to the requested cancelation booking becoming available. This ensures that all positions can be filled before allowing replacement of bookings to allow the user who has requested cancellation of the booking sufficient time to change their mind.

In yet a further embodiment, the system may provide a delayed cancellation system, in which a user may cancel a booking and allow a cooling off period, for example 30 minutes, before the cancelled booking is available to other users. This allows a user to change their mind if their circumstances regarding the booking alter. It will be appreciated that any other booking period may be used. A booking period may be also correspond to a rule, for example, the rule may require all available bookings to be filled before cancellation can occur, or may require a further user to book the cancelled booking time period to have the first booking cancelled. It will be appreciated that a first booking is the booking being cancelled and a second booking may be a subsequent booking which replaces the first booking.

It will be appreciated that at least one interaction between a user of the system and the system may generate at least one data set. Data may be generated, for example, by searching, making a booking, cancelling a booking, performing a check, performing a process, or any other system process or function may generate at least one data set. Data sets may be used by the system to store or manipulate existing data or be used to generate new data.

For example, a booking request may generate a first data set, which can be modified by at least one of the client or the system. The first data set may be modified by requesting an amendment, such as requesting change of services or cancelling the booking, which may generate a second data set. As an example, the user may request to limit or extend the time period which has been booked provided that the centre has the capacity to allow the request. This may result in the first data set being modified.

The core processes of the system may include at least one of; sign up process and log-in, login/logout and password processes, single or multiple booking requests, single or multiple placement requests, single person, multi person, booking to placements search, expanded geography booking to placements search, flexible data booking to placements search, refined booking to placements search, booking to placements search match overview display, prioritise booking to placements search match, booking to placements search match sort, display search match on a map, select search match for booking processing, modify or cancel booking to placements search, placement availability management, optionality to enable centres to place positions, optionality for centres to cancel a placement, replacement of a new booking, search new placement against booking waitlist, placement validation, CRM functionality, communications between and to centres and users, communications between and to centres and users, remove booking, remove placement or any other predetermined core process.

The waitlist processes may include at least one of; waitlist optionality for booking user, probability of booking/placement match and processing assessment, waitlist prioritisation, or any other predetermined waitlist process.

The notification processes of the system may include at least one of; placing user booking processed notification, booking user booking processed notification, centre booking/placement exchange notification, centre acknowledgement of booking changes, centre booking changes review, booking user waitlist match, placing user waitlist match, notification of record update requirements, of centre profile edits or additions and approve for display, or any other predetermined notification process.

The payment processes of the system 10 may include at least one of; storage of user payment information, update of user payment information, facilitate booking payment by booking user, facilitate credit/refund/reward to placement user, facilitate payment to centre, facilitate payment to business, or any other predetermined payment process.

The user profile may include at least one of the following features; create an accessible ‘child’ record, capture, storage and validation of child records, enable ‘child’ record information to be shared, enable ‘child’ record to be updated and or deleted, enable ‘child’ record to be linked to parent record, create an accessible ‘parent’ record, enable ‘parent’ record information to be shared, enable ‘parent’ record to be updated and or deleted, enable ‘parent’ record to be linked to parent record, enable the attachment or inclusion of representations of documents such as birth certificates, medical records or forms of identification or any other predetermined user profile feature.

A centre profile may include at least one of; review centre profile, create and edit centre profile, user search and review of centre profiles, centre promotion, or any other predetermined centre profile feature.

The rating feature of the present disclosure may include at least one of; centre rating system, centre rating edit and approval, calculate centre rating, display centre rating, or any other predetermined rating feature.

The reporting functionality may include at least one of; utilisation reporting to centres, user bookings and placements report, user schedule view and booking/placing action, updating of centre attendance and records, or any other predetermined centre reporting functionality. Further, centre support may allow for updating of centre administration systems.

The special functions of the system may comprise at least one of; booking and placing incentives, referral process, loyalty system, routine booking waitlist management system, user authenticity, or any other predetermined special functions feature.

In yet another embodiment, the system has a waiting list which users can request to be added to a queue and be assigned a priority based on at least one of; profile status.

In yet a further embodiment, the system may have a priority status in which a user with a higher priority status may be able to be added to the waiting list above users with a lower priority status. For example, if a user indicates that there is an emergency, or other need, and an urgent booking is essential for the user, the system or a centre may assign a user a high priority such that the probability of securing a booking is increased.

In yet a further embodiment, further value can be added by the system operating as a service aggregator, which can be adapted to manage vacancies created by cancellations, regardless of how the initial booking was made, and enabling others to utilise the otherwise potentially vacant capacity with limited involvement of the actual service provider. Further, the system may comprise an aggregator which allows access to data stored by multiple service providers across different platforms. This may allow more than one service provider to access the system even if each uses differing platforms for bookings and/or management. This may allow for cross platform aggregation with multiple data sets for use with the system. It will be appreciated that data sets may have different formats.

In yet another embodiment, the system may allow a user to make a booking through a means which is not the system, but then may allow the user to access the system to alter a booking or otherwise provide data or input to the system. Preferably, alterations to a booking are made via the system, however a centre may also make modifications to a booking upon request on behalf of the user.

In at least one embodiment, it will be appreciated that altering a booking for services can include at least one of; cancelling a booking, swapping a booking, amending a time of a booking, shortening or expanding the length of a booking or any other predetermined alteration which can be allowed by the system.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

What is claimed is:

1. A system for booking services, the system comprising:
a server;
the server adapted to receive at least a first data set input by a first user;
the first data set comprising at least one data set for a booking for services;
the server adapted to receive a revised first data set input by the first user to modify the first data set to alter the booking for services, such that a second user can send a second data set to the server to book for services in place of the first data set; and
wherein the first data set is modified after receiving the second data set.

2. The system as claimed in claim 1, wherein the first user and the second user have a respective user profile.

3. The system as claimed in claim 1, wherein at least one of the first user profile and the second user profile each have an associated client profile.

4. The system as claimed in claim 1, wherein the first data set further comprises at least one of; booking time data, a booking period data, booking date data, data relating to a requirement for the booking, data relating to a request for the booking, client data, user data, and authorized user data.

5. The system as claimed in claim 1, wherein the system is adapted to aggregate data from a plurality of service providers, such that the system can modify a booking for a user.

6. The system as claimed in claim 1, wherein a payment is required from the second user to book for services in place of the first data set before the first data set is modified after receiving the second data set.

7. The system as claimed in claim 1, wherein the system is adapted to perform a check for at least one available booking at a requested booking time.

8. The system as claimed in claim 7, wherein when there is not at least one available booking at the requested time, at least one alternative available booking can be offered to a user, if there is at least one alternative available booking.

9. The system as claimed claim 8, wherein the at least one alternative available booking is offered with respect to at least a requested booking time and/or a location of the booking.

10. The system as claimed in claim 9, wherein the location of the at least one alternative available booking is within a predetermined radius the location of the booking.

11. The system as claimed in claim 1, wherein the system comprises a wait list in which users can queue for the booking in place of the first user.

12. The system as claimed in claim 11, wherein the users on the wait list are assigned a rank which relates to the time in which each respective user is added to the wait list.

13. The system as claimed in claim 12, wherein when the first user alters the booking for services, an availability notification is sent to at least one user on the wait list to such that a second user can book services in place of the first user.

14. The system as claimed in claim 12, wherein users on the wait list can request to swap waiting list ranks, such that a user added to the wait list at a later time can swap with a user added to the wait list at a respective earlier time.

15. The system as claimed in claim 14, wherein a user with a respective later time offers an incentive to a user with a respective earlier time to swap waiting list ranks.

16. The system as claimed in claim 1, wherein when the second user sends the second data set to the server to book for services in place of the first data set, such that the first user receives a partial reimbursement of an original booking fee.

17. The system as claimed in claim 16, wherein the partial reimbursement of the original booking fee reimbursed to the first user is relatively larger when the second user has booked services in place of the first data set within a predetermined time period.
